(19) United States
(12) Patent Application Publication
(10) Pub. No.: US 2012/0205212 A1
(43) Pub. Date: Aug. 16, 2012

(54) Torque Transmission Arrangement, Particularly A Hydrodynamic Torque Converter

(75) Inventors: Ralf FAMBACH, Schonungen (DE); Georg MENCHER, Grafenrheinfeld (DE); Gregor SUECK, Coesfeld (DE); Andreas GRELL, Schweinfurt (DE); Michael HEULER, Wurzburg (DE)

(73) Assignee: ZF Friedrichshafen AG, Friedrichshafen (DE)

(21) Appl. No.: 13/369,190

(22) Filed: Feb. 8, 2012

(30) Foreign Application Priority Data
Feb. 9, 2011 (DE) 10 2011 003 844.2

(51) Int. Cl. F16D 47/06; F16D 13/40

(52) U.S. Cl. 192/3.29; 192/66.3

(57) ABSTRACT

A torque transmission arrangement includes a housing arrangement which is drivable for rotation around an axis of rotation and a clutch arrangement in the torque transmission path between the housing arrangement and a driven member. The clutch arrangement has a first friction surface formation, which is rotatable with the housing arrangement and a second friction surface formation, which is rotatable with the driven member, and a clutch piston, which is movable axially for producing and canceling a frictional engagement of the first friction surface formation with the second friction surface formation. A piston carrying element, which is connected in a substantially fluid-tight manner to the clutch piston on the radially inner side, permits an axial movement of the clutch piston. The piston carrying element is produced substantially in its entirety from plastic material.

### BACKGROUND OF THE INVENTION

1. Field of the Invention

The present invention is directed to a torque transmission arrangement, particularly a hydrodynamic torque converter, comprising a housing arrangement that is drivable for rotation around an axis of rotation and is filled or fillable with fluid, a clutch arrangement in the torque transmission path between the housing arrangement and a driven member, which clutch arrangement has a first friction surface formation rotatable with the housing arrangement and a second friction surface formation rotatable with the driven member, a clutch piston movable axially for producing and canceling a frictional engagement of the first friction surface formation with the second friction surface formation, and a piston carrying element connected in a substantially fluid-tight manner to the clutch piston on the radially inner side and which permits an axial movement of the clutch piston.

2. Description of the Related Art

A torque transmission arrangement of the type mentioned above constructed as a hydrodynamic torque converter is known from U.S. Pat. No. 7,143,880 B2. In this known torque transmission arrangement, the annularly formed piston, which is displaceable for engaging and disengaging a lockup clutch, is supported and guided in its radially outer area at an outer disk carrier in an axially movable and fluid-tight manner. In its radially inner area, the clutch piston is supported in an axially movable and fluid-tight manner and guided for axial movement, respectively, at a likewise annularly formed piston carrying element and at the outer circumferential surface thereof, respectively. This piston carrying element is connected to a housing shell of the housing arrangement for rotating jointly by welding. In its radially inner area, the piston carrying element is held at an axial distance from this housing shell and, at that location, also axially supports the driven member, which transfers torque and is provided as a turbine hub. To obtain a fluid-tight connection of the clutch piston to the piston carrying element, the clutch piston has a circumferential groove in its inner circumferential surface located radially opposite the outer circumferential surface of the piston carrying element, an annular sealing element being received in this circumferential groove.

### SUMMARY OF THE INVENTION

It is an object of the present invention to provide a torque transmission arrangement, particularly a hydrodynamic torque converter that has an improved operating behavior and is constructed in a simple manner.

According to one embodiment of the invention, a torque transmission arrangement, particularly a hydrodynamic torque converter, comprises a housing arrangement that is drivable for rotation around an axis of rotation and is filled or fillable with fluid, a clutch arrangement in the torque transmission path between the housing arrangement and a driven member, which clutch arrangement has a first friction surface formation rotatable with the housing arrangement and a second friction surface formation rotatable with the driven member, a clutch piston movable axially for producing and canceling a frictional engagement of the first friction surface formation with the second friction surface formation, and a piston carrying element connected in a substantially fluid-tight manner to the clutch piston on the radially inner side and which permits an axial movement of the clutch piston.

It is further provided that the piston carrying element is produced substantially in its entirety from plastic material.

Producing the piston carrying element from plastic material is comparatively simple and economical and also affords a very high degree of freedom with respect to shaping and integration of various functionalities in the piston carrying element so that the various functional areas of this piston carrying element can be adapted in an optimal manner to any requirements which may occur.

The piston carrying element can have a sealing element receiving cutout in its radially inner end region and/or in its radially outer end region. A cutout of this kind can be incorporated in a simple manner during the production of the piston carrying element, for example, in an injection molding process.

Further, it is proposed that the piston carrying element provides in its radially inner end region a first axial supporting area for axial support of the driven member with respect to the piston carrying element. Accordingly, a defined positioning can be predetermined for the driven member in a reliable manner. It can further be provided that the piston carrying element provides a second axial supporting area in its radially inner end region for axial support of the piston carrying element with respect to the housing arrangement.

According to another aspect of the present invention which is also to be considered independently, it is proposed that the piston carrying element is not connected to the housing arrangement by melt joining. This avoids work processes that can lead to deformation of the housing arrangement due to the application of heat as is required, for example, for welding.

For example, the piston carrying element can be joined to the housing arrangement so as to be fixed with respect to rotation relative to it by positive engagement.

To this end, rotational coupling members engaging in rotational coupling cutouts of the piston carrying element can be provided at the housing arrangement.

The positive engagement can also be realized, for example, in that a toothing formation is provided at the housing arrangement, and in that a mating toothing formation which engages in a rotationally coupling manner with the toothing formation is provided at the piston carrying element.

In an alternative variant which can be realized in a very simple manner with respect to construction, it is proposed that the piston carrying element is supported axially at the housing arrangement and is connected to the latter in circumferential direction by frictional engagement.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention will be described in the more detail in the following with reference to the accompanying drawings. The drawings show:

FIG. 1 is a partial longitudinal section through a torque transmission arrangement constructed as a hydrodynamic torque converter;

FIG. 2 is an enlarged detail of the torque transmission arrangement from FIG. 1 in a radially inner area of a piston carrying element;

FIG. 3 is a view of another embodiment form corresponding to FIG. 2;

FIG. 4 is a view of another embodiment form corresponding to FIG. 2;

FIG. 5 is a view of another embodiment form corresponding to FIG. 2;

FIG. 6 is a view of another embodiment form corresponding to FIG. 2; and

FIG. 7 is a view of another embodiment form corresponding to FIG. 2.

### DETAILED DESCRIPTION OF THE PRESENTLY PREFERRED EMBODIMENTS

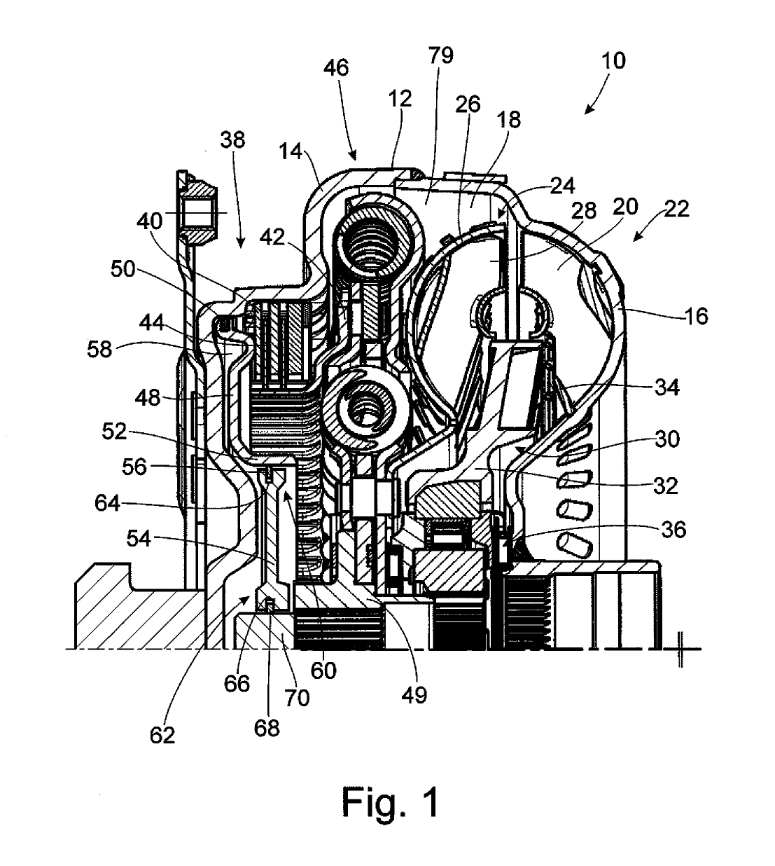

A torque transmission arrangement constructed in the form of a hydrodynamic torque converter is designated generally by 10 in FIG. 1. This torque transmission arrangement 10 comprises a housing 12 having a housing shell 14 which is to be positioned on the drive side, i.e., engine side, and a housing shell 16 positioned on the driven side, i.e., transmission side. These housing shells 14, 16 are fixedly connected to one another in a fluid-tight manner on the radially outer side, for example, by welding, so as to form an interior space 18 which is closed in a fluid-tight manner.

A plurality of impeller vanes 20 arranged successively in circumferential direction around an axis of rotation A is supported at the housing shell 16 so that the housing shell 16, or housing 12 generally, also provides an impeller 22. A turbine 24 having a plurality of turbine vanes 28 supported successively in circumferential direction around the axis of rotation A at a turbine shell 26 is provided in the interior space 18. A stator, designated in general by 30, is located between the impeller 22 and the turbine 24 and has a stator ring 32 that carries a plurality of stator vanes 34 successively in circumferential direction and is supported on a supporting hollow shaft, by a freewheeling arrangement 36 so as to be rotatable in one direction around the axis of rotation A.

A lockup clutch 38 comprises a plurality of disk-like friction elements 40 connected to the housing shell 18 to be fixed with respect to rotation but axially movable relative to it. These friction elements 40 provide a first friction surface formation. A plurality of disk-like friction elements 44 which are connected to a friction element carrier 42 so as to be fixed with respect to rotation but axially movable relative to it provide a second friction surface formation which is connected by a torsional vibration damper arrangement 46 to a driven member 49 which is provided in the form of a hub.

The torsional vibration damper arrangement 46 is constructed in two stages with two torsional vibration dampers that act in series and are arranged in a radially staggered manner. The friction element carrier 42 is connected to the primary side of the radially outer torsional vibration damper of the two torsional vibration dampers, this primary side being constructed as a central disk element. The damper springs of these torsional vibration dampers transmit the torque to two cover disk elements held at an axial distance from one another and form the secondary side of the first torsional vibration damper in their radially outer area and the primary side of the second torsional vibration damper in their radially inner area. The damper springs of the second torsional vibration damper transmit torque to the driven member 49 via a central disk element providing the secondary side of the second torsional vibration damper. The turbine shell 26 is fixedly connected to the two cover disk elements by riveting or the like and, together with the latter, provides an intermediate mass between the two spring assemblies of the two torsional vibration dampers.

It should be noted in this connection that the torsional vibration damper arrangement 46 shown in FIG. 1 and the lockup clutch 38 can be constructed in different ways. It is also possible, of course, to connect the second friction surface formation 33 to the driven member 49 directly, i.e., without the intermediary of a torsional vibration damper arrangement.

A clutch piston 48 is annularly formed and provided in the interior space 18 of the housing 12 to press the two friction surface formations, i.e., friction elements 40 and 44, into a mutual frictional engagement. This clutch piston 48 is guided on the radially outer side at an inner circumferential surface area of the housing shell 14 to be axially movable and, by inserting an annular sealing element 50, also fluid-tight. On the radially inner side, the clutch piston 48 is guided by a substantially cylindrical portion 52 in a fluid-tight manner on a piston carrying element 54. This piston carrying element 54 is constructed in its outer circumferential area with an annular sealing element 56 so that a space area 58 which is closed so as to be substantially fluid-tight is formed between the clutch piston 48 and the housing shell 14.

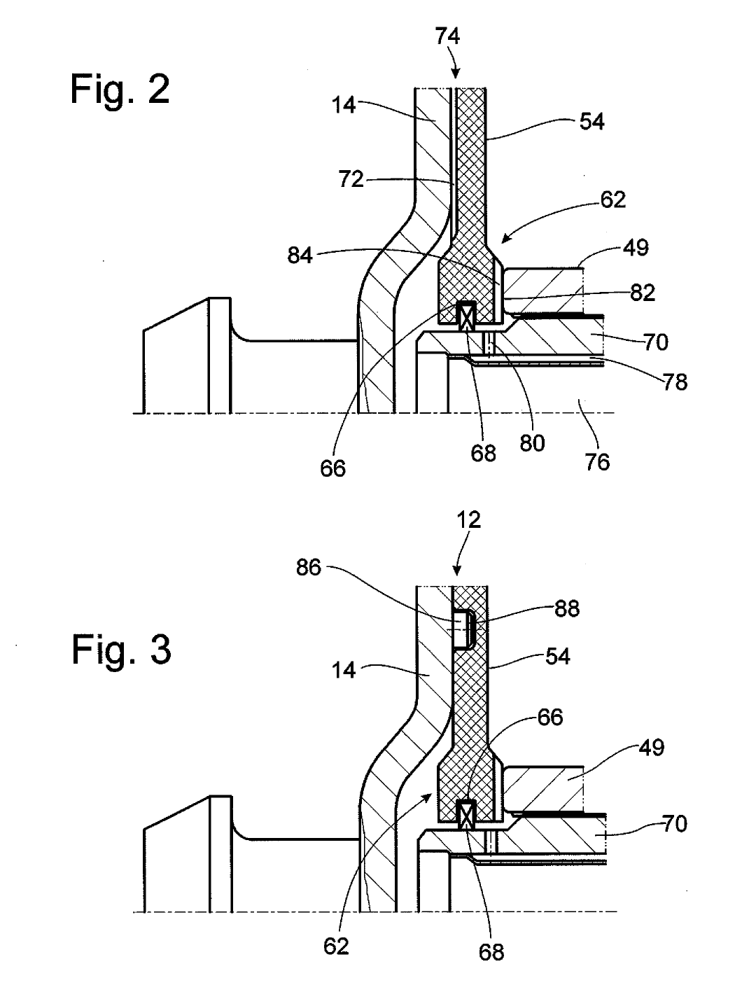

In the construction of the torque transmission arrangement shown in FIGS. 1 and 2, the piston carrying element is constructed in its entirety from plastic material. In its radially outer end region 60 and in its radially inner end region 62, it has sealing element receiving cutouts 64 and 66, respectively, which open radially outward and radially inward, respectively, and receive the sealing element 56 and, on the radially inner side, a sealing element 68. In this way, the piston carrying element 54 is connected in a fluid-tight manner to the clutch piston 48 and to a transmission input shaft 70 which is indicated only schematically in FIG. 1 and which can be seen clearly in FIG. 2.

To supply the space area 58 with fluid and to remove fluid from this space area 58, a channel arrangement 74 is provided in the piston carrying element 54 by a plurality of groove-like channels 72 extending from the radially inner end region 62 to the radially outer end region 60. The transmission input shaft 70 is constructed as a hollow shaft having a central opening 76 through which the fluid can be delivered in the direction of the space area 58 and also received again from the latter. In order that fluid can also be supplied to and removed from a space area 79 containing the turbine 24, the transmission input shaft 70 is double-walled and has an annular channel 78 which opens radially outward via one or more openings 80 into a space area which is closed by the sealing element 68 axially in a fluid-tight manner. In the radially inner end region 62 in which the piston carrying element 54 provides an axial supporting area 82 for the driven member 49, the piston carrying element 54 has one or more openings 84 which lead radially outward and which can open axially, i.e., toward the piston carrying element 54. The driven member 49 connected to the transmission input shaft 70 so as to be fixed with respect to rotation relative to it can exert a load on the piston carrying element 54 such that the latter, by pressing against the housing shell 14, is coupled with the latter for jointly rotating around the axis of rotation. A relative rotation then takes place between the axial supporting area 82 and the driven member 49.

To ensure that the piston carrying element 54 is rotationally coupled with the housing 12, particularly with the housing shell 14, in a defined manner irrespective of the axial load exerted by the driven member 49, a positive engagement can be provided as is shown in the constructional variant illustrated in FIG. 3. To this end, rotational coupling projections 86 can be formed at the housing shell 14, for example, by forming shaped portions, and can engage in corresponding rotational coupling cutouts 88 of the piston carrying element 54 and therefore secure the latter in a defined manner.

Of course, this type of rotational coupling can be combined with the channels 72 shown in FIG. 2, in which case the rotational coupling cutouts 88 then preferably lie between two channels 72 arranged successively in circumferential direction.

The rotational coupling between the piston carrying element 54 and the housing shell 14 can also be carried out by toothing formations provided at these structural component parts and that are brought into mutual engagement when the piston carrying element 54 is fitted axially to the housing shell 14.

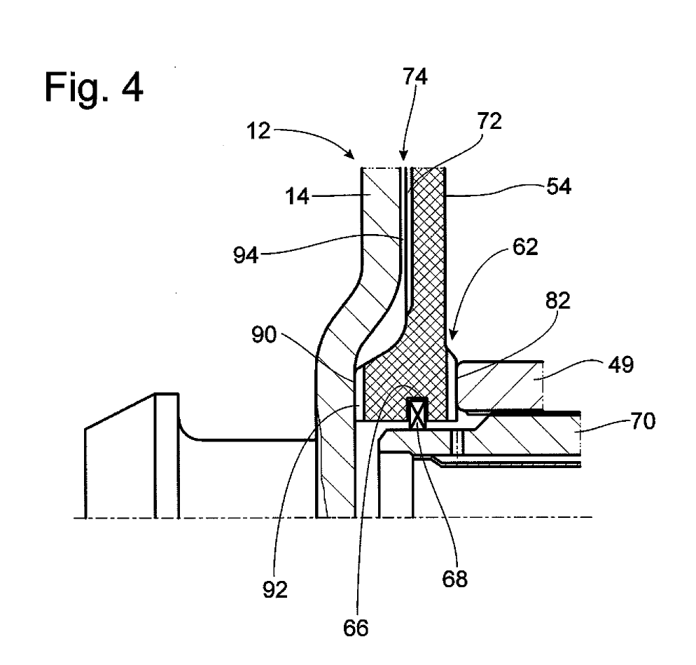

Another variant is shown in FIG. 4. It can be seen that the piston carrying element 54 not only provides an axial supporting area 82 for the driven member 49 in its radially inner end region 62, but has another axial supporting area 90 in which it is axially supported at the housing 12, in this case in the housing shell 14. To allow fluid to pass radially outward and from the radially outer side, respectively, the piston carrying element 54 can have one or more openings 92 in this region which are open, e.g., axially.

Accordingly, in this embodiment, an axially continuous force feedback short circuit is provided so that axial loads exerted by the driven member 49 cannot lead to a deformation of the piston carrying element 54 in its radially inner area. Since in this constructional variant the piston carrying element 54 is positioned in an axially defined manner through axial support with respect to the housing 12, it is possible to realize the channel arrangement 70 by loading a gap-like intermediate space 94 between the piston carrying element 54 and the housing shell 14 as an alternative to or in addition to providing the channels 72.

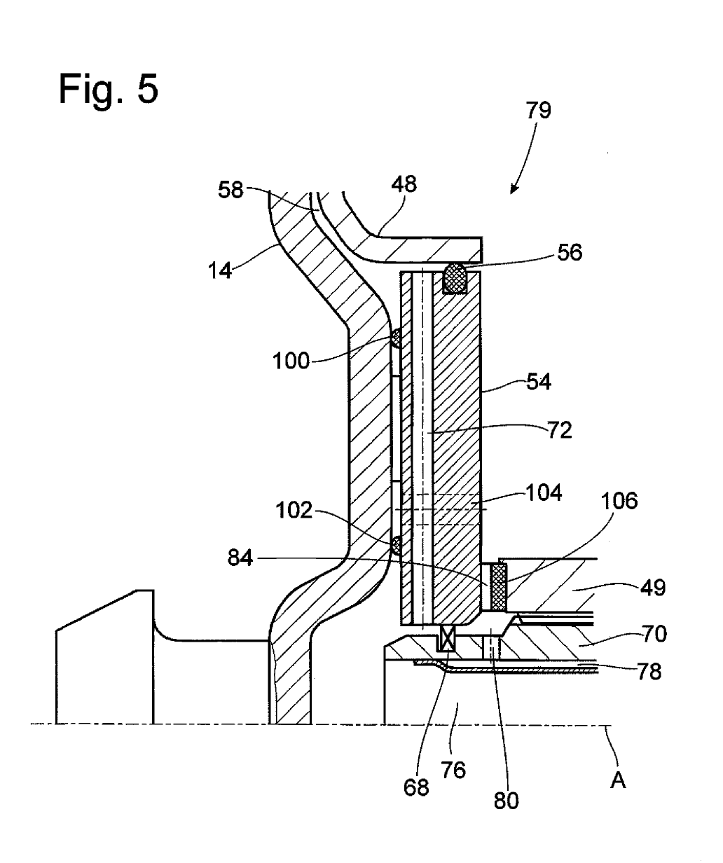

FIG. 5 shows another embodiment. The piston carrying element 54 is constructed as an injection molded part of plastic material extending substantially annularly around the axis of rotation A. This injection molded part is supported axially at the axial side facing the housing shell 14 by two axially acting sealing elements 100, 102 which are positioned at different radial levels and are, for example, vulcanized on or rubber-mounted. Rotational coupling with the housing shell 14 can be provided, for example, by rivet connection elements, which extend axially through the piston carrying element 54 and engage behind the housing shell 14 at the side remote of the housing shell 14, and which can be formed by shaped portions of the housing shell 14.

To produce a pressure equalization with respect to the volume area radially enclosed between the two sealing elements 100, 102, one or more connection openings 104, indicated by dashed lines, are provided, which produces a connection to the space area 79 and, therefore, a pressure compensation.

One or more channels 74 penetrate the piston carrying element 54 in radial direction to allow fluid to be supplied to and removed from the space area 58.

The driven member 49 is axially supported by an annular supporting element 106 at the radially inner area of the piston carrying element 54. Groove-like openings 84 allow fluid to pass to and from the space area 79 in this annular supporting element 106. The supporting element 106 is held in a radially centered manner at the driven member 49.

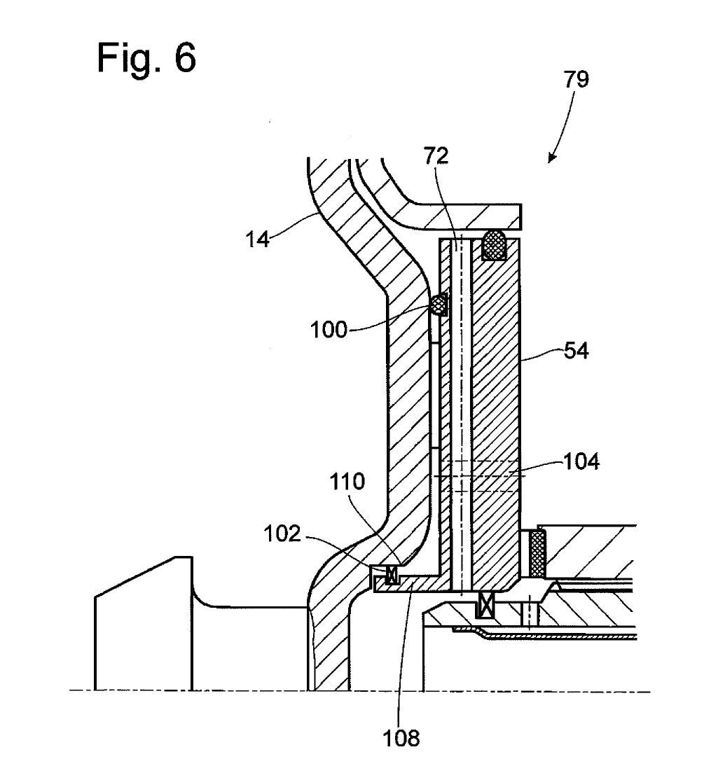

A modification of this embodiment form is shown in FIG. 6. It can be seen that the seals 100, 102 in this case are not rubber-mounted or vulcanized on but rather are inserted into corresponding groove-like cutouts in the piston carrying element 54. The radially inner seal 102 is provided at the outer circumference of a substantially axially extending cylindrical shoulder 108 of the piston carrying element 54 and sealingly contacts an inner circumferential surface 110 formed at the housing shell 14. In this case also, the volume area formed between the two seals 100, 102 is connected to space area 79 by one or more openings 104 for pressure equalization.

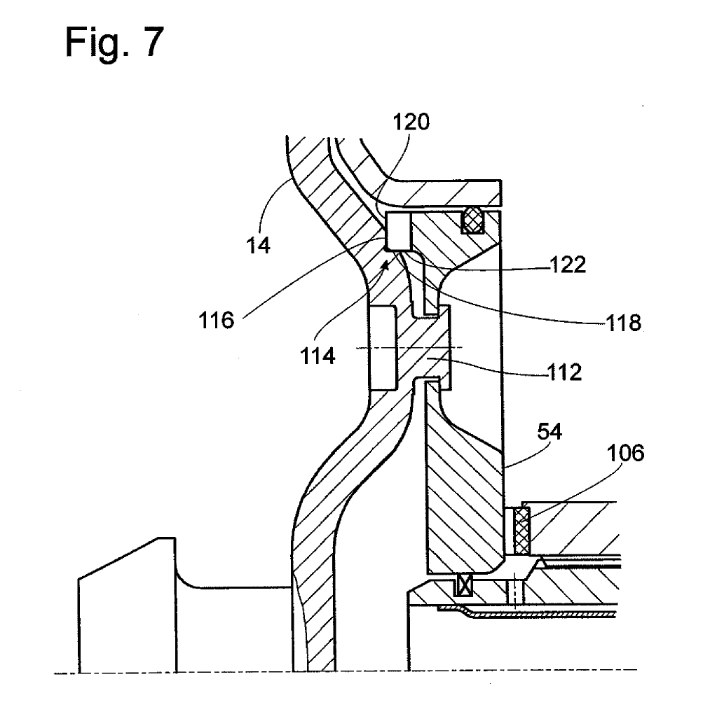

FIG. 7 shows an embodiment form in which a piston carrying element 54 is substantially shaped like an annular disk and is formed of plastic material connected to the housing shell 14 by rivet connection elements 112, which also provide the rotational coupling. These rivet connection elements 112 are provided by shaped out portions in the housing shell 14 and, in this embodiment form, provide substantially only for the rotational coupling and for holding together axially. The axial and radial centering is brought about in this instance by a centering formation 114. This centering formation 114 comprises an axial surface 116 and a radial surface 118 at the housing shell 14. This axial surface 116 and radial surface 118 lie opposite an axially directed surface 120 and a radially directed surface 122 at a radially outer, axially projecting region of the piston carrying element 54 and ensure centering by mutual contact.

It should be noted that, of course, centering is also provided, or can be provided, in the other embodiment forms described above. This centering can also be realized in particular by the structural assemblies providing a rotational coupling between the piston carrying element and the housing or a housing shell.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A torque transmission arrangement, comprising:
a housing arrangement which is drivable for rotation around an axis of rotation and is one of filled or fillable with a fluid; and
a clutch arrangement in a torque transmission path between the housing arrangement and a driven member, the clutch arrangement having:
a first friction surface formation rotatable with the housing arrangement;
a second friction surface formation rotatable with the driven member,
a clutch piston that is axially movable to produce and cancel a frictional engagement of the first friction surface formation with the second friction surface formation; and
a piston carrying element connected in a substantially fluid-tight manner to the clutch piston on a radially inner side that permits the axial movement of the clutch piston,
wherein the piston carrying element is produced substantially in its entirety from plastics material.

2. The torque transmission arrangement according to claim 1, wherein the piston carrying element has a sealing element receiving cutout in at least one of its radially inner end region and its radially outer end region.

3. The torque transmission arrangement according to claim 1, wherein the piston carrying element provides in its radially inner end region a first axial supporting area for axial support of the driven member with respect to the piston carrying element.

4. The torque transmission arrangement according to claim 1, wherein the piston carrying element provides a second axial supporting area in its radially inner end region for axial support of the piston carrying element with respect to the housing arrangement.

5. The torque transmission arrangement according to claim 1, wherein the piston carrying element is not connected to the housing arrangement by melt joining.

6. The torque transmission arrangement according to claim 5, wherein the piston carrying element is connected to the housing arrangement by positive engagement for rotating jointly around the axis of rotation.

7. The torque transmission arrangement according to claim 6, wherein rotational coupling members are provided at the housing arrangement that engage in rotational coupling cutouts of the piston carrying element.

8. The torque transmission arrangement according to claim 6, wherein a toothing formation is provided at the housing arrangement, and a mating toothing formation is provided at the piston carrying element that engages in a rotationally coupling manner with the toothing formation provided at the housing arrangement.

9. The torque transmission arrangement according to claim 5, wherein the piston carrying element is supported axially at the housing arrangement and is connected to the housing arrangement in circumferential direction by frictional engagement.

10. The torque transmission arrangement according to claim 1, wherein the torque transmission arrangement is a hydrodynamic torque converter.

11. The torque transmission arrangement according to claim 2, wherein the piston carrying element provides in the radially inner end region a first axial supporting area for axial support of the driven member with respect to the piston carrying element.

12. The torque transmission arrangement according to claim 11, wherein the piston carrying element provides a second axial supporting area in the radially inner end region for axial support of the piston carrying element with respect to the housing arrangement.

13. The torque transmission arrangement according to claim 12, wherein the piston carrying element is connected to the housing arrangement by positive engagement for rotating jointly around the axis of rotation.

14. The torque transmission arrangement according to claim 13, wherein rotational coupling members are provided at the housing arrangement that engage in rotational coupling cutouts of the piston carrying element.

15. The torque transmission arrangement according to claim 7, wherein a toothing formation is provided at the housing arrangement, and a mating toothing formation is provided at the piston carrying element that engages in a rotationally coupling manner with the toothing formation provided at the housing arrangement.
